(19) United States
(12) Patent Application Publication
(10) Pub. No.: US 2023/0182027 A1
(43) Pub. Date: Jun. 15, 2023

(54) INTERACTIVE CLOUD-BASED GAMING METHODOLOGY

(71) Applicant: Adventure Games, Inc., San Diego, CA (US)

(72) Inventors: Chad Hardy, San Diego, CA (US); Didier Boulvin, Bruxelles (BE)

(73) Assignee: Adventure Games, Inc., San Diego, CA (US)

(21) Appl. No.: 17/813,107

(22) PCT Filed: Jan. 16, 2021
(86) PCT No.: PCT/US2021/013765

§ 371 Date: Jul. 18, 2022

Related U.S. Application Data
(60) Provisional application No. 62/962,590, filed on Jan. 17, 2020.

(51) Int. Cl. A63F 13/847; A63F 13/335; A63F 13/352; A63F 13/69

(52) U.S. Cl. CPC A63F 13/847; A63F 13/335; A63F 13/352; A63F 13/69

(57) ABSTRACT

A gaming methodology with improved player and team interface may feature a cloud-based gaming architecture (410) with either cloud or locally based interactive game files. At least one processor (420) then controls at least one display (430) to provide direction, interaction, and otherwise advance gameplay. Players and teams interact with the game from personal devices (440a-440d), such as smartphones or tablets, to further advance gameplay. The methodology may incorporate actors (450), specialized tokens, or geographically significant tokens (460) to advance the game. The game methodology may also be implemented across a plurality of locations with multiple displays (430) and more particularly allow teams of players to cooperate.

### CROSS-REFERENCES TO RELATED APPLICATIONS

This application claims priority on prior filed PCT Application number PCT/US2021/013765, filed Jan. 16, 2021, which in turn claims priority to U.S. Application No. 62/962,590, filed Jan. 17, 2020, and incorporates the same by reference in its entirety.

### TECHNICAL FIELD

The present invention relates to the field of gaming and more particularly relates to an interactive cloud-based game which utilizes players' personal devices.

### BACKGROUND OF THE INVENTION

Play and games are a pastime with a rich history. Ever since ancient times, people have been devising games as both entertainment and training scenarios. Making use of the human need for “fun” makes gaming particularly effective in training scenarios where children and even adults can learn how to do various tasks. Group participation in games tends to lead to greater camaraderie and cohesiveness in the participating group. Even sporting events, where spectators merely watch and cheer for a preferred participant or team of participants, can lead to greater camaraderie between the spectators. Simply the display of emblems or logos of favorite teams or games can instantly form a bond between two people who otherwise have no other knowledge of each other. The shared experience of games is a useful foundation on which relationship and community can be developed.

One more recent development in the cooperative/community game is the escape room. Escape rooms are immersive experiences where players are locked in a room and work together to solve puzzles leading to the escape of the room. Typically, players are given a time limit in which to accomplish their escape. Rooms are usually themed to a particular time or genre. Most feature a moderator to ensure smooth running of the game. In some cases, an actor may also be featured in the room and serve as a moderator or possibly as a part of the game itself.

Another team cooperation game is the scavenger hunt. In a scavenger hunt, players search for items on a list and the first one to find all the items, or the most items in a set time frame, wins. This concept is easily adapted for teams. It is also easily modernized by merely requiring players to take a picture of a desired object. As such, objects could be pictures of people performing stunts or activities, landmarks, animals, or other things as proof of finding the object.

The community that may develop between participants of games is particularly useful in team-building exercises in professional, academic, and personal settings. Team-building games have been used in business for some time now to build cohesiveness and cooperation between employees. Usually, these games feature a series of tasks which employee/team members must complete to advance. There are professional organizations which will set up and run such games for businesses. Usually, such organizations can only serve local businesses, or they must send teams to the location of the client business to deliver their services. Modern technology has developed which can allow such organizations to set-up and run team building games remotely.

Some games have been developed whereby players utilize their personal devices to play them. These games on-board players by connecting devices to a central processor. One of the most popular interactive on-boarding games is the JACKBOX series, where games are presented through a display and users on-board through personal devices. However, these games tend to be individual games and utilize simple trivia or opinion-based input. They typically do not present a fully immersive experience, playing only audio clips based upon player responses, and only show progress in a base form. These game apps also have only one display source for the game (even if it could be divided into individual local displays or broadcast through video conferencing applications). Therefore, current interactive, on-boarding games require players to be on the same network and, ideally, in the same room. They also are limited to individual play and players (typically 8 as a maximum), no team building scenarios exist in this art, much less with larger numbers of players and teams.

The present invention is a cloud-based gaming methodology which incorporates the community development of escape or scavenger-style games with a mobile platform allowing it to be implemented in any Internet enabled geographic region. Organizers may remain at one place or send a small team to a client's locale to create a more fully immersive experience than was previously able to be accomplished. The present invention represents a departure from the prior art in that the methodology of the present invention allows for an interactive team-based game to reside on the Internet cloud while still providing the building experience in multiple locations.

In view of the foregoing disadvantages inherent in the known types of gaming methodologies, an improved cloud-based game may provide a locally stored or streamed video storyline that pauses to allow player and team input from cloud connected personal devices, such as smartphones or tablets. Such a game should meet the following objectives: that it be readily implemented across many platforms and locations, that it be receptive to player input, that it provides an immersive experience that more easily allows player to suspend disbelief in its playing, that it may utilize actors and/or local geographic features in its game architecture, and that is open to varied forms of player input, that individual players and teams may receive individualized prompts from the game system. As such, a new and improved gaming methodology may comprise a base game system stored on the cloud with video files which may be streamed or downloaded and played for player immersion and that it utilizes current communication technology to allow player input and direct the flow of game play to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic of one embodiment of a game utilizing locally stored interactive files.

FIG. 2 is a schematic of another embodiment of a game utilizing entirely cloud-based interactive files.

FIG. 3 is a schematic of a third embodiment of the game, as shown in FIG. 2, played across a plurality of locations.

FIG. 4 is a fourth embodiment of a game utilizing both actors in the location of play and real-world tokens to be found during play.

FIG. 5 is a basic flowchart applicable to most embodiments of the gaming methodology.

### BEST MODES FOR CARRYING OUT THE INVENTION

With reference now to the drawings, a preferred embodiment of the game methodology is herein described. It should be noted that the articles “a”, “an”, and “the”, as used in this specification, include plural referents unless the content clearly dictates otherwise.

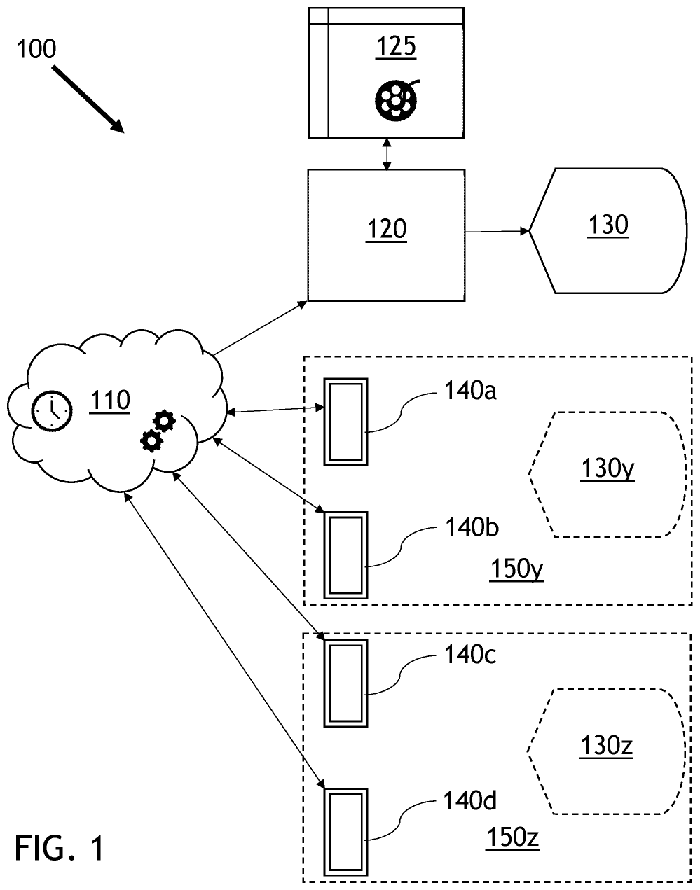

With reference to FIG. 1, in one embodiment (100) of implementing the game methodology, basic game architecture (110) is cloud-based and allows a processor (120) to download certain game directing files to a memory (125) to facilitate game play. The architecture (110) includes the basic rules, story outline, system files, game clock, and other necessary files, instruction, and code to run the game. The game directing files are designed to provide instruction and clues to players who are viewing the files and playing the game and may be any type of media file, whether video, audio, text, or any other file. These game directing files are then played, as directed by the game architecture (110), on at least one display (130). Individual players utilize their personal devices (140a), (140b), (140c), (140d), which may be smartphones, tablets, or any other web-enabled input/output device. The input/output devices run an app and display media files to interact with the game architecture on the cloud (110). The architecture (110) directs an app on the personal devices (140a-140d) to display input prompts for the players. The game architecture (110) contains many inputs which must be received by players to advance the game. Inputs may be freeform or multiple-choice inputs from the players and may be individualized to specific players and teams. Advancement may be accomplished by providing either correct or incorrect input. However, proper advancement (that leading to game completion) may be limited to only occurring by providing correct input. Points may be given based upon either time or position in which proper input is provided. Teams (150y), (150z) may be formed by grouping individual players into playing groups and assigning cooperative tasks within the structure of the game architecture. Each team may use individual input/output devices (140a-140d) and the display (130) in their game experience or may gain benefit from a unique team display (130y), (130z) for individualized team content. In this manner, teams may be physically located in the same or in different locations.

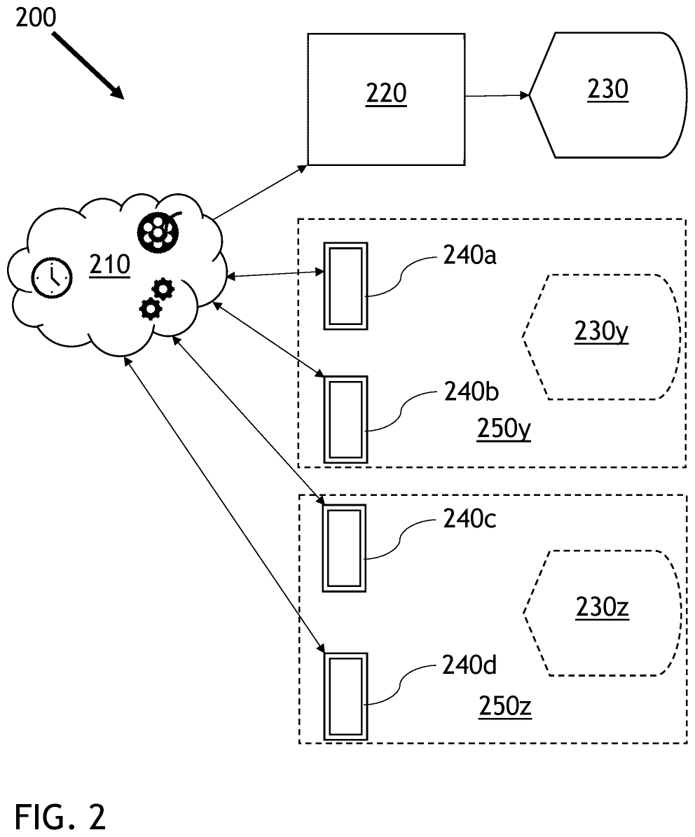

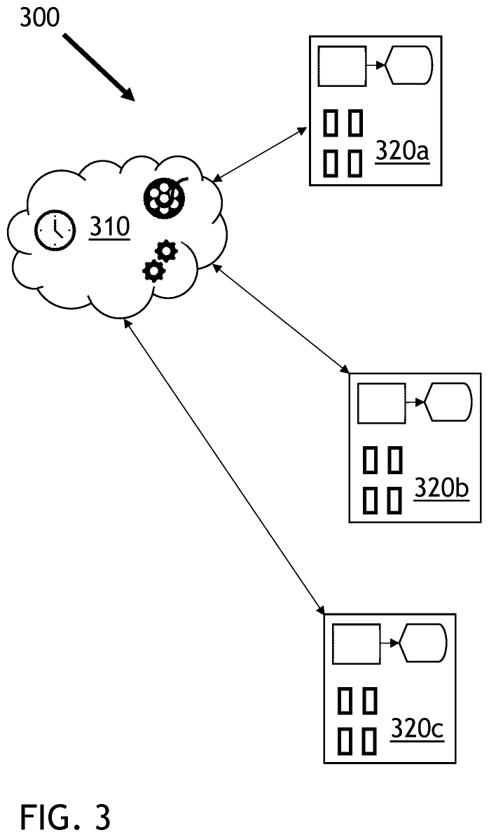

FIG. 2 depicts an embodiment (200) with wholly cloud-based game architecture where the game architecture and interactive files reside on the cloud (210), and the architecture directs playing of the interactive files on display (230) connected to processor (220). Players still on-board the game by connecting their personal devices (240a-240d) to the cloud-based architecture (210). Either methodology may be utilized in a truly remote setting (300), as shown in FIG. 3, where the game architecture (310) is connected to multiple game locations (320a), (320b), (320c). In such cases, care must be taken to properly synchronize the remote locations for proper display and scoring from gameplay. Each “location” may be an individual team acting in cooperation to achieve game directives.

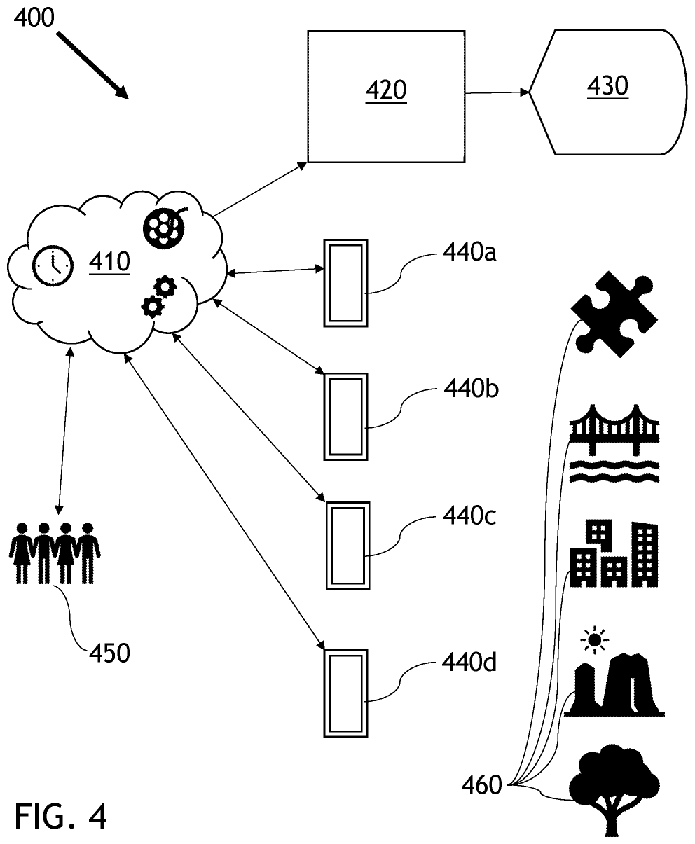

FIG. 4 depicts a more interactive embodiment (400) where not only is the game architecture (410) controlling a display (430) through a processor (420), and players are on-boarded though their devices (440a-440d); but physically present actors (450) are utilized to provide a sub-system of personal interaction outside the devices. In such cases, the actors (450) must have some communication with the game architecture (410) to coordinate timing of their parts with the game and possibly provide input to advance the game. The input may also be in the form of tokens (460) in which the game architecture (410) must recognize before proceeding with the game. Tokens (460) may be anything, but may include and not be limited to specialized planted tokens specific to the game, visiting local landmarks, addresses, natural phenomena, and points of interest. Information may then be drawn from the token and used as game input. In the event pictures of tokens are utilized as responses to game prompts, the game architecture can include recognition algorithms to specifically identify required tokens and filter out pictures which may have been obtained from online sources.

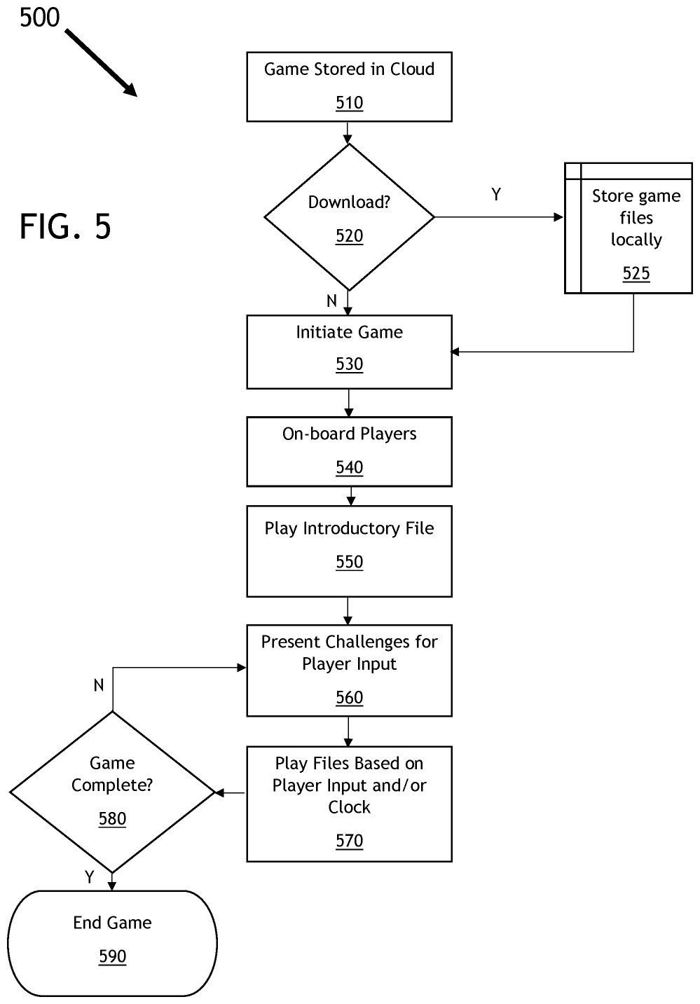

The basic methodology (500) may be seen in FIG. 5. The game architecture and interactive files are stored in the cloud (510) and the interactive files may be downloaded locally (525) at the option of the gamemaster (520). The game is then initiated (530) and individual players on-boarded (540) by installing an app on their personal devices. An introductory file is played to initiate gameplay (550) and a challenge presented to players (560). Players then provide input to the game architecture through their devices (570). This input may be anything that the game architect has programmed into the gaming architecture. It could be information provided from the interactive files, actors, external locations, solving puzzles and riddles, photographic depictions of desired clues, etc. Any input can then free the architecture to play additional files (570) or spur actors to provide other information or plot development. Once played, the architecture can then determine if the game is complete (580) and either provide more challenges or end the game (590). Team play may be accomplished assigning players to teams after onboarding (540) or after the playing of introductory files (550) and then by sharing input/output devices or by coordinating individual challenges (560) as presented through media files between individual players such that individual team members receive prompts directing them on cooperative or individual quests within team objectives established in the game architecture.

The game architecture itself is easily incorporated to an escape room or a scavenger hunt styled game. The use of the interactive files allows the architect to fashion a game around any genre or time-period and utilize any form of input desired. The interactive files may include puzzles to solve or direct players to find certain objects, or both and combine the two types of game. Proper synchronization of the game to the players' devices is also a key factor in enhancing realism and the suspension of disbelief. As such, single site of hosting game architecture is vital. The single site serves as a game clock and may then send prompts to both the display processor and the players' devices, even across multiple physical locations. Proper synchronization also allows for the interactive files to include certain elements that “break the fourth wall” and enhance the experience. The use of actors on-site allows for a fuller immersion experience which enhances the community of the players in the shared experience. The game methodology of the present invention is fully flexible and will only become more flexible as technological breakthroughs improve the interaction of people to machines. Utilizing an artificial intelligence in the architecture, or even just a learning algorithm, is also contemplated in this specification. Game architecture is ideally suited to team play and cooperation, thus providing the team-building environment. The flexibility provided by the methodologies outlined herein provide a freer environment to not only provide the team-building experience, but also free the architect's imagination in constructing the games.

Although the present invention has been described with reference to preferred embodiments, numerous modifications and variations can be made and still the result will come within the scope of the invention. No limitation with respect to the specific embodiments disclosed herein is intended or should be inferred. Among potential variations, games may be stored remotely and accessed as a subscription service.

### INDUSTRIAL APPLICABILITY

The present invention has industrial applicability games may be developed through current programming and entertainment industries.

1. A gaming system comprising:
a cloud-based game architecture, further comprising a game clock, game rules, story outline and system files;
a plurality of game directing media files;
at least one display on which the plurality of media files may be displayed,
a plurality of Internet-enabled player input/output devices providing interaction with the gaming system;
at least one environmental token external to the game architecture and located in the real world;
wherein the game architecture allows for individual players to be assigned to teams and the at least one environmental token is an object which must be found outside of the game.

2. The gaming system of claim 1, the game directing media files being stored at a local location, where a game may be played.

3. The gaming system of claim 1, the game directing media files also being cloud-based.

4. The gaming system of claim 1, the gaming method being executed simultaneously in a plurality of locations.

5. The gaming system of claim 1, the at least one environmental token being specific to a locale in which the gaming method is executed.

6. The gaming system of claim 1, further comprising interaction with the gaming system aside from the input/output devices.

7. The gaming system of claim 1, media files being displayed in a manner to coordinate teamwork.

8. A gaming system comprising:
a cloud-based game architecture, further comprising a game clock, game rules, story outline and system files;
a plurality of game directing media files;
at least one display on which the plurality of media files may be displayed,
a plurality of Internet-enabled player input/output devices providing interaction with the gaming system;
a sub-system of interaction outside of the player input/output devices; and
at least one environmental token external of the game architecture and located in the real world;
wherein the game architecture executes the game in a plurality of locations and allows for individual players to be assigned to teams, including coordinating display of media files to facilitate said teems, while utilizing the at least one environmental token located at each of the plurality of locations.
